(19) United States
(12) Patent Application Publication
(10) Pub. No.: US 2001/0051924 A1
(43) Pub. Date: Dec. 13, 2001

(54) On-line based financial services method and system utilizing biometrically secured transactions for issuing credit

(76) Inventor: James Uberti, Marina del Rey, CA (US)

Correspondence Address: CHRISTIE, PARKER & HALE, LLP, 350 WEST COLORADO BOULEVARD, SUITE 500, PASADENA, CA, 91105, US

(21) Appl. No.: 09/846,927

(22) Filed: Apr. 30, 2001

Related U.S. Application Data
(60) Provisional application No. 60/203,041, filed on May 9, 2000.

(51) Int. Cl. G06F 17/60

(52) U.S. Cl. 705/44; 705/35

(57) ABSTRACT

A method and system for issuing biometrically-secured online credit without tokens or cards. Buyer initiates registration wherein buyer provides personal information and a biometric sample to a detection server. The detection server communicates with a credit issuing institution to establish a credit account. Upon issuance of credit, the detection server forwards the biometric sample to a third party clearinghouse, which enrolls the biometric sample. Buyer is then able to securely originate transactions on any computer system of choice since access to their financial services is only allowed through biometric authentication of the buyer. Once registered, the buyer accesses a seller's website to make a purchase and presents a biometric sample. The detection server forwards the biometric sample to the clearinghouse. Upon successful match from clearinghouse approval is sent to the detection server for issuance of a one-time credit card account number, which automatically populates the buyer's payment information online.

### CROSS-REFERENCE TO RELATED APPLICATIONS

This application claims the benefit of U.S. provisional Application No. 60/203,041, filed on May 9, 2000, the content of which is incorporated herein by reference.

### BACKGROUND OF THE INVENTION

The invention relates to the field of issuing biometric secured credit on-line and at retail point of sale locations, and more particularly to a secure system for carrying out transactions on-line using biometrics to issue and authorize credit and debit transactions. No images or raw biometric data are stored at any point in the biometric system, either on the client, webserver, or central repository. Instead, biometric templates—files containing distinctive elements derived from the original biometric sample—are utilized. To complete online transactions, the buyer will submit a biometric sample, which is forwarded by our detection server to a third party clearinghouse. Verifications are returned to the detection Server and routed to a credit code database, at which point a disposable credit card number is issued. This one-time credit card number is passed directly to the merchant, and the web transaction proceeds as normal. Merchants will verify this one-time code and the associated data submitted from the biometric credit system.

This single-use credit card number represents the point of commonality between the invention and the existing online payment infrastructure, and allows the leveraging of existing purchasing processes. Unlike existing single-use credit cards, the invention is not predicated on a link to a static credit card number (which would pose a security risk) but to a buyer's ID number, which is meaningless outside the context of the biometric credit payment network.

Single-use credit card numbers offer much higher levels of security than standard cards, as they have a finite lifespan: even if hacked, which would require penetration of encrypted databases, they are only usable once, by a certain person, at a given time, and with a short expiration period. Once a buyer is issued a number for a transaction, an account database flags the time of issuance and the buyer to whom it was issued. When the merchant verifies the number, the merchant is ensured that the information provided matches the account information used in card issuance. As a result of the invention, Buyers will be able to securely originate transactions on any computer device of choice since access to their financial services is only allowed through biometric authentication and identification of the buyer.

As a result of this invention, the Buyer does not have to provide their biometric information to every merchant or financial company they do business with, which would in turn greatly increase the risks of theft, loss or having their biometric information sold. The invention will eventually link with merchant web sites, banks, credit bureaus and credit processors.

### SUMMARY OF THE INVENTION

Internet commerce has grown astronomically over the last few years. As the Internet has grown, so too have concerns about the possible abuse, privacy issues, and lack of security with making credit card payment transactions over the Internet. In addition, for Buyers who regularly make web based purchases, the need to continually fill out the same types of information, including credit card and delivery and billing information, across different web sites becomes tedious and time consuming. It also heightens the possibility that this confidential information can be illicitly obtained by personnel at the merchant's web site, or others who may hack into the web site. Of similar concern is the possibility that a Buyer's credit card information has been wrongfully obtained, and an unauthorized Buyer is using the stolen credit card to make purchases and have these purchases shipped to an address other than the credit card owner's home or office. Encryption, by itself, does not adequately address this problem.

Merchants offering their goods and services over the Internet have dealt with security concerns in a variety of ways. For example, various encryption schemes are presently used to enhance web based transactions, and are intended to encrypt the Buyer's credit card number and the credit card's expiration date, and possibly other ordering informing such as the Buyer's mailing and billing addresses. One common concern expressed by Buyers conducting transactions on the Internet is that while some merchants purport to offer a high level of security for web based transactions, in practice many web merchants do not actually take adequate precautions to guard the Buyer's credit card and other confidential information. Particularly when dealing with smaller and lesser-known merchants, Buyers may, for good reason, not be willing to give private information over the Internet. To allay these concerns, some large Internet merchants offer Buyers the option to call in and/or fax in credit card information. These additional, non-web based steps require additional human involvement and intervention, and therefore can interrupt an otherwise automated ordering and authentication process. Side effects of this manual process include the potential for human error and additional transaction costs.

In cases where unauthorized credit card transactions take place; it is usually the merchant (that has likely already shipped the goods to the unauthorized party), which bears the loss. This loss comprises not only the cost of the goods, but also damage to the merchant's reputation as a secure place to shop.

Another shortcoming of web-based commerce is the tedious and time consuming re-entering of the same type of payment and shipping information necessitated by the Buyer. The system of the invention will perform authentication and credit authorization as stated above, and will also provide the ability for the Buyer to register their shipping information with the system. Information will be provided to the merchant, thus resulting in the added convenience of using the online credit system of the invention.

Just as fraud in Internet transactions is of concern to e-merchants, fraud remains a problem for merchants engaged in face-to-face commerce, and costs merchants and credit card issuers huge amounts of money. In addition to fraud, the requirement of a customer to carry not only a credit card but also several pieces of identification can be troublesome. These costs are ultimately passed onto merchants and Buyers. What is needed is an improved web-based system that gives Buyers the option to purchase goods more securely and with less tedious input required, and a system that saves merchants from the costs of fraud, provides merchants with lower credit transaction fees, and permits customers to make purchases anytime, anyplace, and without carrying any credit cards or any extraneous forms of identification.

A private and secure biometric enrollment and verification system, portable to any e-commerce environment, is the centerpiece of the invention.

Visitors to a partner bank's website powered by the biometric payment system apply for a line of credit, just as they would in traditional credit card environment. Approved buyers are prompted to enroll their biometric information via voice-scan or keystroke-scan; these technologies are available to the essentially all-online purchasers. After enrollment, the partner bank will approve a small amount of credit that is made available for immediate use. Buyers will submit biometric information to make online purchases. When prompted for payment information, buyers need only provide a biometric sample. A biometric template is extracted on the local PC from the buyer's live sample, and transmitted through a detection server to the biometric clearinghouse computer systems for verification.

Verifications are returned to the detection credit code database, at which point a disposable credit card number is issued. This one-use, time-sensitive credit card number is passed directly to the merchant, and the web transaction proceeds as normal. Merchants will verify this one-time code and the associated data submitted from the biometric credit system.

In order to provide maximum levels of response time and accuracy, the invention's primary biometric credit verification is based on finger-scan biometrics, but the invention also incorporates technologies such as facial-scan, voice-scan, and keystroke-scan. Upon initial credit issuance, enrollment takes place through voice-scan or keystroke-scan, while a finger-scan device will be the appliance of choice for subsequent transactions. For long-term usage, finger-scan is currently the technology best capable of addressing commercial requirements for performance, ease of use, and affordability.

Buyers approved for credit after application processing and identity verification will be prompted to enroll preferably via voice-scan or keystroke-scan technology. Enrollment grants immediate access to a small amount of their authorized credit line. A finger-scan device is preferably immediately shipped to the buyer; after enrollment of the buyer's finger-scan information, the remaining credit line is made available for subsequent transactions.

The primary buyer interaction with the biometric system will be during verification. Enrollment, though critical to the system's operation, is normally a one-time event. The process flow of enrollment is designed to ensure that a high-quality biometric template is gathered. Verification, on the other hand, is designed from a procedural and technology perspective to meet customer expectations for a fast, simple purchase. Buyers are preferably presented with a brief tutorial on device usage demonstrating high-quality enrollment procedures for voice and keystroke-scan. Pre-enrollment screens will prompt buyers to speak their passphrase or type a password to ensure that the quality of the enrollment is sufficient.

The reliance on biometric templates as opposed to biometric images is a key privacy, security, and performance-enhancing feature. Templates cannot be used to recreate a buyer's original biometric information, a strong protection against misuse of biometric data. From a security perspective, a buyer's biometric template is not static. A unique template is derived from each finger placement, such that the template cannot be used to track a buyer's purchases across multiple systems.

From a data flow perspective; the biometric matching and post-match transmission components of the invention are separate. The former relates directly to comparison of biometric information, while the latter describes the result of a biometric decision. However, from the customer perspective, the match and its result are part of the same process. The expectation is that placement of a finger will be followed within a few seconds with a match and an authorized transaction.

The biometric verification interface will only be necessary at the time of purchase, when a buyer is prompted to enter credit card information. This biometric interface is the front end of the detection server, which is responsible for gathering data to be matched at the central clearinghouse.

As during enrollment, the buyer will provide information in order to be verified biometrically. This unique identifier may take the form of a cookie placed on the buyer PC or a buyer-specified ID. This identifying information will accompany the biometric template transmitted for verification.

Simultaneously with buyer identification, the interface locates the payment interface on the e-commerce site. This is to provide a destination for the single-use credit card generated after the biometric match.

Assuming that the biometric and credit verifications are successful, the account code database generates a single-use credit card for this specific transaction. This is routed back to the merchant interface, at which point the transaction proceeds as normal. From the customer's perspective, the purchase can be made without needing to know a credit card number; from the merchant's perspective, a transaction has occurred which can be verified through standard processes; and from the company's perspective, the identity of the customer has been verified with a very high degree of certainty, resulting in issuance of the single-use card for a specific transaction.

The invention ultimately facilitates secure and convenient online credit purchasing by verifying the identity of the credit buyer. The success of biometric credit does not require changes to the merchant's current transactional infrastructure. Current online disposable card numbers are difficult to use, requiring pages of information to be filled out before a credit purchase can be verified and completed by existing payment processes. Biometric credit systems simplify and secure the disposable credit card process by consolidating two functions.

Once the identity of an individual has been verified, the authorization server will have the task of issuing one-use, time sensitive credit numbers that can be utilized by the existing credit card processing system. The two vital factors of verifying identity and credit availability must be satisfied to gain access to existing legacy banking systems. The biometric credit system addresses these concerns by interacting with the present infrastructure used in processing credit. The buyer will then be able to use credit at any Internet merchant capable of processing VISA, MasterCard or other credit card transactions, opening the entire online credit market to an online card issuing financial services company.

The invention's biometric verification system provides value by enabling highly trusted transactions. To do so, it must interact with existing technology and interface at the client and merchant levels. The biometric system interacts with external, non-biometric systems and processes at several points, as noted below.

Most buyer's first biometric experience will take place at the biometric enrollment website or credit issuing bank's website. Tight integration of the biometric processes at the site is important.

Biometric credit services will be designed to integrate into existing e-commerce platforms, while the back end verification and data storage components will be capable of migrating to newer platforms.

Many of the logistical issues involved in handling biometric data—storage, security, encryption, and comparison—are tasked to the clearinghouse. The clearinghouse will have the ability to scale to a large numbers of buyers, as well as the ability to work with multiple platforms and biometric technologies, and offer a highly secure and stable infrastructure. There are a number of biometric clearinghouses and data centers under development; there is no market leader in this area. One of the major challenges facing this developing area is a lack of an established biometric market. Though there are a handful of large biometric databases in existence, they are single-use databases, designed for a specific application. Biometric clearinghouses will be populated from the ground up, as opposed to leveraging existing biometric databases.

Above and beyond the enrollment and verification processes, a number of procedural protections are in place to ensure consistent, secure, and reliable system operation for customers and merchants.

Though most buyers will use the same finger for most of their transactions, enrolling a second finger is necessary as a fallback in case of cuts or changes in skin condition. The buyer will select the first finger to be enrolled and place the finger on the device. An image is captured and presented, showing the quality of the placement. The buyer is prompted to lift the finger. Assuming that the placement is usable, the buyer is asked to place again; if the first placement was of insufficient quality, the buyer is notified and places again. This process is repeated until a minimum number of consistent and high-quality placements are gathered for the first finger, at which point the buyer enrolls his or her second finger.

Depending on the finger-scan peripherals deployed, templates can be generated either on the device or on the local PC. For applications in which security is an extremely important factor, creation of the template on the device eliminates the very slight possibility that sensitive information might be captured in transit to the local PC. These “trusted” devices could also incorporate data/time stamp into a biometric transmission. However, this is a more expensive solution, as more processing power needs to be built into the peripheral.

There will be situations in which data residing in the matching database will need to be updated, such as in cases of re-enrollment of the same or different fingers. The movement of data will follow the same basic procedures outlined above. Templates are generated locally, either on the PC or on a peripheral device, and are transmitted in encrypted fashion through the biometric company website to the central clearinghouse. Depending on the technology partners involved, a buyer may need to verify against their enrolled data as a precondition of updating biometric information.

Buyer ID Creation and Biometric Enrollment will be separate processes, as very few applicants will have biometric devices on their desktops. In order for Buyer ID Creation and Biometric Enrollment to comprise a single process, biometric units would need to be present on desktops as buyers are submitting their biometric credit applications. Over the next few years, as biometric devices begin to reach an appreciable percentage of buyer desktops, these processes will effectively be folded into one.

One of the potential vulnerabilities of a web-based authentication system is replay attacks. If a transmission from a remote PC to the web server were compromised, the transmission data could be resent in an effort to make unauthorized purchases. To counter this, biometric systems can be designed to verify that a biometric template has not been used in recent transactions. In conjunction with the biometric clearinghouse, the invention will check incoming verification templates against hashes of the buyer's most recent verification templates. This will ensure that biometric data is not being used fraudulently—two different biometric templates from the same buyer should never generate the same hash value.

If the first biometric verification attempts are unsuccessful, buyers will have the option of verifying through additional biometric technologies such as voice-scan and keystroke scan. Nearly all buyers have microphones either as peripheral or embedded devices, so voice-scan is available to most buyers. Keystroke-scan, which measures typing patterns, in available to anyone using a PC, and offers completely discreet verification.

In another embodiment of the invention, the computer system communicates with one or more external computer systems in order to perform various functions, including determining if the buyer has sufficient credit resources, the debiting of a buyer's financial account, the crediting of the seller's financial account, or the construction of a credit authorization draft.

The present invention is clearly advantageous over the prior art in a number of ways.

First, it is very easy and efficient for the Buyer to use because it eliminates the need to carry and present any tokens in order to access one's accounts. The present invention reduces many of the inconveniences associated with carrying, safeguarding, and locating tokens. Further, because tokens are often specific to a particular computer system that further requires remembering a secret PIN code assigned to the particular token, this invention eliminates all such tokens and thereby significantly reduces the amount of memorization and diligence increasingly required of Buyers by providing protected access to their credit accounts using only one personal identification number. The Buyer is now uniquely empowered, by means of this invention, to conveniently conduct his personal and/or professional electronic transactions at any time without dependence upon tokens, which may be stolen, lost or damaged.

The invention is clearly advantageous from a convenience standpoint to retailers and financial institutions by making purchases and other financial transactions less cumbersome and more spontaneous. The seller and the Buyer significantly reduce the paperwork of financial transactions as compared to credit card purchases wherein separate receipts are generated and must be retained.

Further, the substantial manufacturing and distributing costs of issuing and reissuing tokens such as credit cards, debit cards, telephone calling cards and the like will be reduced, thereby providing further economic savings to issuing banks, and ultimately to Buyers.

Moreover, the invention is markedly advantageous and superior to existing systems in being highly fraud resistant. Present authorization systems are inherently unreliable because they base determination of a buyer's identity on the physical presentation of a manufactured object along with, in some cases, information that the buyer knows. Unfortunately, both the token and information can be transferred to another person, through loss, theft or by voluntary action of the authorized buyer. Thus, unless the loss or unintended transfer of these items is realized and reported by the authorized buyer, anyone possessing such items will be recognized by existing authorization systems as the Buyer to whom that token and its corresponding financial accounts are assigned.

By contrast, the present invention virtually eliminates the risk of granting access to unauthorized buyers by determining identity from an analysis of a buyer's unique characteristics. It is an object of the invention therefore to provide a commercial credit transaction system that eliminates the need for a buyer to possess and present a physical object, such as a token, in order to authorize a transaction.

It is another object of the invention to provide a commercial credit transaction system that is capable of verifying a buyer's identity based on one or more unique characteristics physically personal to the buyer, as opposed to verifying mere possession of proprietary objects and information.

Yet another object of the invention is to provide a commercial transaction system that is practical, convenient, and easy to use, where buyers no longer need to remember multiple PINs to protect multiple accounts.

Another object of the invention is to provide increased security in a very cost-effective manner, by completely eliminating the need forever more complicated and expensive tokens.

### BRIEF DESCRIPTION OF THE DRAWINGS

The accompanying drawings, which are incorporated in and constitute a part of the specification, illustrate presently preferred embodiments of the invention. Together, with the general description given above and the detailed description of the preferred embodiments given below, they explain the principles of the invention.

FIG. 1 is a diagram illustrating a process for the issuance of Biometric Credit™, including credit evaluation from an issuing bank and the enrollment of at least one biometric sample.

FIG. 2 is a diagram depicting an authentication process flow as a Buyer uses the invention to make a biometrically secured credit transaction consistent with the invention.

FIG. 3 is a diagram showing the general fashion of the inter-relationship of certain functional and operative computer systems and components consisting of a biometric clearing house, an issuing bank, the detection server and a merchant bank. This diagram illustrates the process for executing a transaction using Biometric Credit™ through the normal payment gateway.

### DETAILED DESCRIPTION OF THE INVENTION

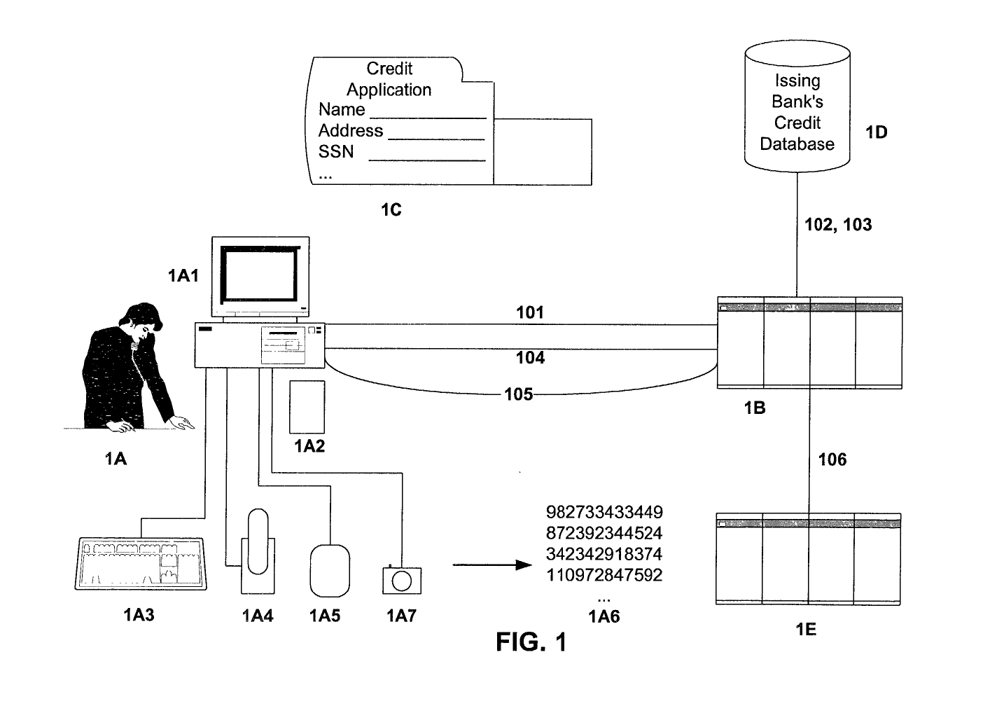

Turning to FIG. 1, there is a diagrammatic view showing one embodiment of the architecture and process of the TouchCredit™ System. To apply for biometric credit™, a Buyer 1A, using a computer 1A1 (PC, MAC, SUN, or any other type) or other digital device, such as a personal digital assistant (PDA)1A2, mobile phone, web enabled TV or Cable TV, or other device (not shown), visits the TouchCredit™ servers website provided by the Detection Server 1B. Buyer is asked to provide personal information in the form of a credit application 1C to be approved for a line of Biometric Credit™. Upon completion of the credit form 1C, it is encrypted, for example, using Secured Sockets Layer (SSL) technology and transmitted via Public Internet 101 to the TouchCredit™ Detection Server 1B. The Detection Server 1B determines the nature of the request, identifies which process is being implemented, and transmits a credit request 102. Credit request is then sent via a private network and secured by, for example, PKI to the issuing bank's or other credit issuer's credit database 1Dor credit authorization sytem.

Once the issuing bank 1D determines a credit decision, the information is again encrypted and transmitted via a private network, preferably secured by PKI 103, to the TouchCredit™ Detection Server 1B for further processing and account database creation.

If credit is not granted from issuing bank ID, the decision is transmitted via 103 to the TouchCredit™ Detection Server 1B. At this point, a determination will be made as to whether account generation is necessary and credit decision is transmitted from issuing bank 1D to Buyer's computer 1A1 via a channel 104, without establishing an account.

If credit is granted from issuing bank ID, the decision is transmitted via a channel 103 to the TouchCredit™ Detection Server 1B to determine if account generation is necessary. The credit decision is then transmitted from issuing bank 1D to Buyer's computer 1A1 via a channel 104 to begin the enrollment process.

An advantage of the invention includes having the ability to extract biometric samples from various devices commonly found on standard computers, PDAs, wireless devices, mobile phones and the like. The aforementioned devices can all be used to capture various types of biometric data. Examples include a computer keyboard 1A3 attached to a computer 1A and a standard microphone 1A4 that can also be used to acquire one's biometric data. In addition, a digital camera 1A7 is also capable of acquiring a Buyer's 1A facial features and/or eye biometric data. For the purpose and embodiment of the invention, Buyers 1A will be prompted by the Detection Server 1B to select a biometric technology of choice. If necessary, buyers will also be asked to download the associated software to enable the existing device to be used to start the enrollment process.

Once approved, a credit account and credit line are established at issuing bank 1D and Detection Server 1B. A credit account may include fields for a credit account number, customer name, customer address and data about the sponsoring organization. Such an organization may have requested, on behalf of the customer, the Biometric Credit™, the total authorized credit line and the amount of the credit line guaranteed. Data recorded by the Detection Server 1B will include such sponsoring organization information and status information showing whether the customer has accepted the line of credit and whether the account has been activated successfully.

Once Buyer 1A accepts credit line, he or she is prompted to enroll their device of choice. This device can either be a voice-scan 1A4 entered by microphone or keystroke-scan 1A3 entered by keyboard, or both. Enrollment grants immediate access to a small amount of their authorized credit line from issuing bank 1D, which is determined and calculated by Detection Server 1B and transmitted via communication link 104 to Buyer's computer 1A1. At this point, the user is setup to make use of the invention and perform biometrically secure credit or debit purchases.

If software is necessary, the user will be asked to select biometric method and to download the appropriate software. Upon completion, the Buyer 1A is presented with a brief enrollment tutorial (preferably no more than about 2 screens) demonstrating high-quality enrollment procedures for voice-scan 1A4 and keystroke-scan 1A3. Pre-enrollment screens will prompt Buyer to speak a pass-phrase or type a password to ensure the quality of the enrollment is sufficient. The pre-enrollment screens will contribute to a successful TouchCredit™ enrollment.

Voice-scan 1A4 enrollment should take less than one minute based on the Buyer 1A reciting his or her pass phrase approximately eight times. The keystroke-scan 1A3 process may take slightly longer than one minute, depending on the Buyer's selection of a pass phrase. The enrollment takes place through interaction with the TouchCredit™ Detection Server 1B and with communication links 104, 105 and 106 active during the enrollment and verification processes.

Buyer 1A will then be asked to provide at least one biometric sample(s) via a biometric input device that is connected to the Buyer's 1A computer 1A1 and/or wireless device 1A2 (such as a finger scanner 1A5, microphone 1A4, face scanner or eye scanner). All aforementioned devices can be incorporated directly into a computer-enabled device and can include any variety of biometric input described.

If a Buyer 1A does not have an embedded finger scanner on his or her computer 1A1, a separate finger-scanning device will preferably be shipped to the Buyer 1A for additional accuracy and security protection. Upon receiving the biometric device, the Buyer 1A will be instructed to register it in order to complete the second enrollment process. After biometric data is successfully enrolled, the Buyer's remaining credit line will be made available for subsequent purchases. Buyers 1A will be motivated to install their biometric device to access the remainder of their credit line or to upgrade to a larger credit line. This process and procedure will be used until such time as biometric devices are ubiquitous.

Due to the requirement for rapid and accurate biometric decisions, the TouchCredit biometric system of the invention operates in 1:1 verification mode, as opposed to 1:NONE identification methodology. This means that a unique ID is provided to the biometric system as a precondition of biometric verification. This authentication methodology increases accuracy, reduces throughput time, and ensures that transactions are secured and tied to a specific buyer's ID.

In order to provide this rapid and secure 1:1 functionality, a unique Buyer ID must be created for association with the Buyer's biometric information. To provide Buyers with control over their purchases, as well as to ensure secure and private transactions, three Buyer ID options are available during enrollment, namely Auto-Assign, Buyer-Specified, and Dual ID Assignment.

The Auto Assign function stores a randomly generated unique Buyer ID in a cookie or purchasing icon 1A11 on the Buyer's web browser or microportal, which was previously downloaded from the Detection Server 1B to the Buyer's Computer 1A1. This Buyer ID is stored in the cookie and or icon 1A11 for retrieval when visiting or utilizing a website for purchasing. When accessing TouchCredit™ services on one's PC using Auto Assign, the Buyer ID is automatically retrieved—the Buyer does not need to remember his or her ID. Under the Auto Assign option, the Buyer only needs to provide a biometric sample/template, as there is no need to enter the Buyer ID using this function. The Buyer ID number, along with the biometric verification template 1A6, is passed through channel 105 to the Detection Server 1B for validation and accuracy. The Detection Server 1B then transmits the biometric ID and Template(s) 1A6 to the Biometric Clearinghouse 1E via communication channel 106 for verification(s).

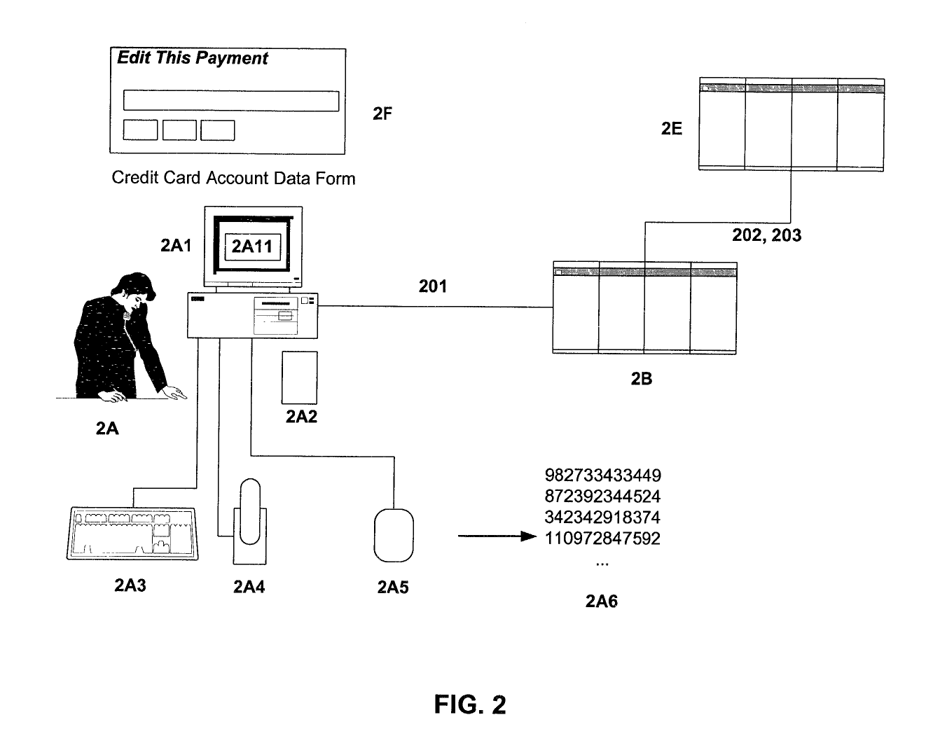

The Buyer-Specified function is more flexible and provides additional conveniences for Buyers 1A planning to make purchases from more than one computer. Buyer-Specified is ideal for Buyers who need the flexibility to purchase at home and/or traveling. The Buyer 1A will select an ID for use in all of his or her transactions. The Buyer's ID must be a unique, but easily remembered ID, such as a phone number or first and last name. The process flow of transacting under Buyer-Specified requires that the Buyer enter the Buyer ID to execute a transaction, as further described in FIG. 2. The Buyer-Specified option may also appeal to customers who prefer not to enable cookies on their local PC.

The Buyer may opt for both a Buyer-Specified and an Auto-Assigned Buyer ID for maximum convenience and flexibility (Dual ID Assignment). One of the invention's benefits is the ability to offer emergency access to cash advances via ATM. For example, if a Buyer has lost his or her wallet, having a Buyer-Specified ID is the fastest way to gain access to emergency funds (although Auto-Assigned Buyers can also gain access to emergency funds). To enable this dual-ID functionality, the Biometric Clearinghouse 1E will be capable of using either of the two unique ID fields to retrieve and match biometric information.

A critical design element of the embodiment of the invention is that no biometric images or samples, i.e. no identifiable biometric data, are stored at any point in the biometric process (whether on the Buyer's computer 1A1 or the Detection Server 1B). Instead, biometric templates 1A6 are utilized throughout the process. The reliance on biometric templates, as opposed to images, is a key privacy, security, and performance-enhancing feature of the invention.

From these biometric sample(s), a biometric template 1A6—a file that contains distinctive elements derived from biometric samples—is created at the Buyer's computer 1A1. The template creation takes place on the Buyer's computer 1A1, a local machine, ensuring that no biometric samples are ever transmitted from the Buyer's computer 1A1 to the TouchCredit™ Detection Server 1B, or anywhere else.

From a performance perspective, templates 1A6 are much smaller than biometric images or samples. Templates are generally 1/100th to 1/1000th the size of their corresponding biometric sample and can be encrypted and processed with very little computing power. Although TouchCredit™ and it's partners will transmit and store all biometric templates 1A6 in a secure fashion, they only have intrinsic value within the context of the TouchCredit network infrastructure associated with the TouchCredit processing mechanisms.

Once enrollment is successful, the biometric template(s) 1A6 are transmitted computer link 105 via SSL from the Buyer 1A to the TouchCredit™ Detection Server 1B for account completion.

Additional non-biometric data is incorporated into the Buyer's record at the TouchCredit™ Detection Server 1B before transmission by channel 106 to the Clearinghouse 1E. This ensures that the record, even if compromised in the Clearinghouse 1E, is secure, as any compromised records would only be useful in conjunction with proprietary TouchCredit™ data. This data will preferably include data/time stamp of record creation, and preferably also TouchCredit™ private keys.

From here, the template 1A6, along with the Buyer ID and proprietary TouchCredit™ data, is transmitted via channel 106 secured via PKI or other means to the Biometric Clearinghouse IE. The Buyer's record is stored at the Clearinghouse IE for use in verifying future TouchCredit™ transactions. Templates 1A6 are transmitted and stored in encrypted format and will only be unencrypted during the verification stages.

Turning to FIG. 2, there is a diagrammatic view showing another embodiment of the architecture and process consistent with the invention. The vast majority of the Buyers' 2A interactions with the TouchCredit™ Biometric System will be in verification. The biometric verification interface will only be necessary at the time of purchase, when a Buyer 2A is prompted to enter credit information 2F. A biometric purchasing icon 2A11 or cookie interface will be located either on an embedded HTML microportal, which is located on the bottom monitor or a hotkey icon located within the web browser or system tray on the user's computer 2A1. The user can activate it with a hotkey, by clicking on an icon 2A11 in the system tray, or by simply placing a finger on the biometric device 2A5. Other devices can be used for biometric input, including a keyboard 2A3, a microphone 2A4, and the like. This icon 2A11 will become the front-end interface. It will act as the trigger mechanism for transmitting data over a secure network 201 connection to the TouchCredit™ Detection Server 2B responsible for gathering and transmitting data 202 to be matched at the Biometric Clearinghouse 2E. Depending upon how a Buyer 2A has configured his or her enrollment interface on his or her computer enabled device such as a PDA 2A2, personal information, such as name and shipping address, may be encrypted and transmitted 201 along with the biometric credit verification, or it may be filled in manually via the Detection Server 2B.

As during enrollment in FIG. 1, the Buyer 2A, will need to provide a PIN number, in addition to providing a biometric sample, in order to verify his/her identity. This unique identifier may take the form of a cookie placed on the buyer's personal computer or a Buyer-specified ID. This identifying information will accompany the biometric template 2A6 transmitted 201 to the Detection Server 2B. This step ensures accuracy and verification of account status prior to transmitting 202 to Biometric Clearinghouse 2E for final biometric template authentication and verification.

The biometric sample is acquired from the biometric device and checked for quality. At this point, a template is generated on buyer's computer 2A1. The template 2A6, along with the user ID, is transmitted 201 to the TouchCredit™ Detection Server 2B preferably via SSL or other secure means. From here, the template and ID are routed 202 to the Biometric Clearinghouse 2E. The user ID is located, and the enrollment template is retrieved.

The two sets of data template 2A6 and buyers specified ID are compared to determine correlation. This takes place on the Clearinghouse Server 2E and is the one point of the biometric process in which the underlying data is not encrypted. As there is no expectation of a 100% match, the Biometric Clearinghouse 2E must use a specific threshold to determine whether a sufficiently high-quality match has taken place.

The score necessary for a given transaction to be declared a match is determined by a proprietary TouchCredit™ algorithm generated through the Detection Server 2B prior to being transmitted via 202 to Biometric Clearinghouse 2E. This algorithm then balances the value and type of transaction with the purchase history of the Buyer 2A. For high-risk, high-value transactions, a relatively high match score will be required and transmitted 202 from Detection Server 2B to Biometric Clearinghouse 2E, whereas a routine purchase could optionally be verified at a somewhat lower threshold. One of the invention's many competitive advantages is the ability to enforce higher levels of authentication for specific transactions in a process invisible to the Buyer 2A.

For example, a user with a history of sub-$100 transactions, when making another low-value transaction, can be considered a match through any verification attempt at or above 95% certainty. If the same user is purchasing an item for $500, the match may be required to return 99% certainty. Furthermore, if someone has attempted to access a user's account 2A unsuccessfully, the account's security threshold may be increased to reduce the likelihood of the account being breached. These adjustments can optionally take place on the fly, such that the threshold can be automatically set to immediately respond to certain transaction types. Note that these percentages do not represent the amount of data in common between enrollment and verification, but instead represent the likelihood that the match is correct. If the correlation does not meet the threshold, a “no match” message is transmitted to Buyer's computer 2A1 from Detection Server 2B. The Buyer 2A is generally allowed three attempts to verify, but this can be adjusted according to transaction type and Buyer history.

If the degree of correlation between the two templates exceeds the transaction threshold, a “match” decision is transmitted to the TouchCredit™ Detection Severs Database 2B and back to the TouchCredit™ website. TouchCredit's selection of and partnership with a Biometric Clearinghouse 2E will be partially based on their ability to perform the processes above very rapidly. Whatever functions can be performed in parallel will be designed accordingly.

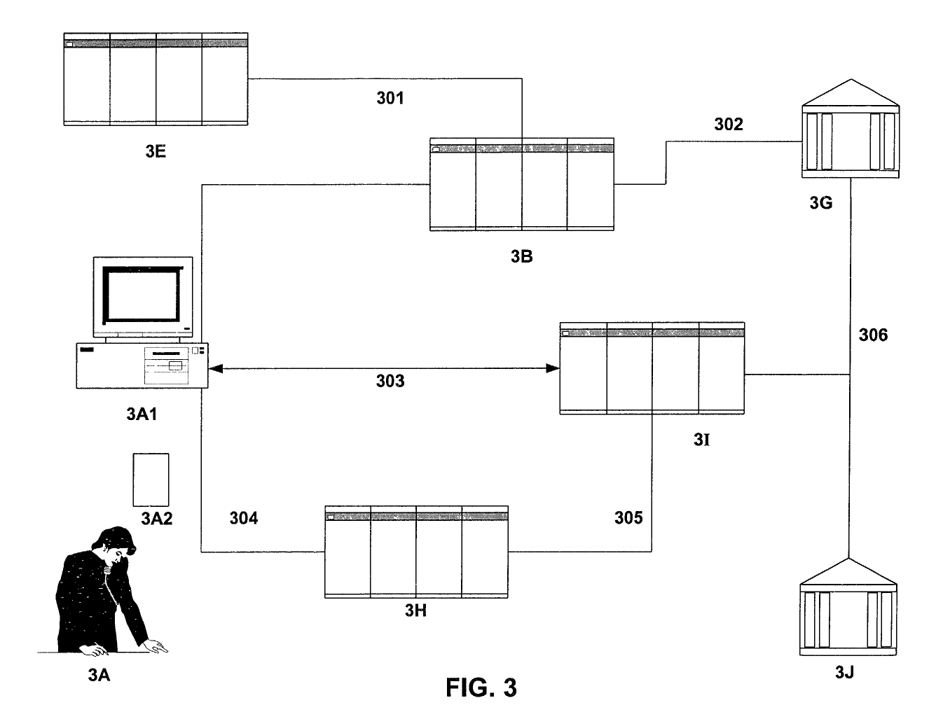

Turning to FIG. 3, there is a diagrammatic view showing yet another embodiment of the architecture and process consistent with the invention. The biometric verification process, as described in FIG. 2, is only half of the transaction equation. TouchCredit™ will verify in its Detection Server's Database that the purchaser's account is valid and active. This non-biometric process can be executed simultaneously with the Clearinghouse-situated biometric comparison in order to minimize transaction-processing time.

Once the biometric match has been performed on the Biometric Clearinghouse Server 3E, the message containing the result of the match is sent to the TouchCredit™ Detection Server 3B via communication link (preferably secure) 301. Once the identity of an individual has been verified, the TouchCredit™ Detection Server 3B retrieves a single-use, time sensitive credit card account number from its database of active single use credit card numbers. Only one transaction can be made at a time using a single-use credit card account number. Once the record is queried, it cannot be accessed again for credit-issuance purposes. This prevents credit card numbers from being used multiple times and allows for single-use credit card numbers to be issued without establishing their values beforehand.

These credit card account numbers are generated by TouchCredit's Partner Bank 3G), a financial institution or a third party provider. This one-time use credit card account number will be utilized and used by existing credit card processing systems. This represents a primary point of interaction between the TouchCredit™ Detection Server 3B) and the Partner Bank 3G. As TouchCredit™ issues single-use card numbers; it will need to have new account numbers generated at regular intervals. Any transmission of these credit card numbers from the Partner Bank 3G to TouchCredit's Server 3B would take place through a private network via 302. It is helpful to think of the TouchCredit™ client software, Detection Server 3B infrastructure and the Partner Bank 3G as one component of the invention, as the TouchCredit™ Detection Server may be closely integrated into the Partner Bank's 3G infrastructure.

The vital factors of verifying one's identity and one's credit availability must be met in order to gain access to the existing legacy banking systems. Our Biometric Credit™ system addresses and allays these concerns by interacting with the present infrastructure used in processing credit. By addressing these factors, Buyer's 3A will be able to use Biometric Credit™ at any Internet merchant's site capable of processing VISA and MasterCard or other credit card transactions, opening the entire online credit market to our financial service partner 3G.

At this point of the transaction, the TouchCredit™ Partner Bank or financial institution 3G has already provided the single-use credit card number via 302. Upon retrieval from the list of active one time use card numbers, the single-use credit card number is linked to the Buyer's 3A unique account number in the TouchCredit™ Database 3B. This is necessary in order to verify information associated with the subsequent purchase. If the SSL session in which the verification was initiated is still open, credit card and expiration date are transmitted via 303 from the TouchCredit Server 3B to the user 3A. As opposed to current single-use credit cards, no value limit is associated with the card at this point—availability of funds is verifies between the merchant bank 3J, the e-commerce retailer 3H, and the issuing bank 3G. The TouchCredit Detection Server 3B can now respond to the user request for credit via 303.

The single-use credit account number and other data may be automatically populated in the merchant form in the user's browser. The user may now proceed to submit the purchase and web form to the merchant web site 3H via 304. The form includes name, address, single-use account number, transaction value, etc. The information is transmitted via 304 once the Buyer 3A has decided to commit to the purchase by selecting a ‘transmit now’ or ‘do you wish to proceed icon/button’ on the web page (not shown). The transaction is sent to the retailer's credit card processing merchant bank responsible for processing online transactions.

Once the merchant web site 3H has received the user transaction data, it proceeds to submit the transaction to a web payment gateway into a credit card authorization network such as VisaNet 3I. VisaNet is an existing network that is part of the standard credit card authorization processing.

The credit card authorization network 3I initiates an inquiry to the TouchCredit Partner Bank 3G via 306. The purpose of the inquiry is to verify available credit in the account identified by the single-use credit account number.

The TouchCredit Partner Bank 3G verifies the status of the single-use credit account and responds to the network 3I via the same session 306. At this point, the network forwards the response to the web merchant 3H via session 305.

The web merchant 3H is finally able to respond to the Buyer 3A via session 304 with an authorization confirmation or denial based on the response it received from the credit authorization network 3I. The user's browser 3A1 receives and displays the transaction status to the user 3A.

One offline-processing step to note is that the credit-processing network 3I is ultimately responsible for settling the transaction between the TouchCredit Partner Bank 3G and the Merchant Bank 3J. The Merchant Bank 3J receives payment for the transaction from the Touch Credit Partner Bank 3G, minus transaction costs and fees.

To recap the systems of the invention, the TouchCredit™ system of the invention will, in effect, be an online/offline biometrics bank issuing credit lines and credit services using biometric technology for the issuance and use of Biometric Credit™ as it relates the embodiment of the invention. As noted above, other types of biometrics information can be utilized. The system will permit consumers to purchase goods and services with a simple “touch here”, “look here”, “speak here” process. The process will authorize at the client site or wireless device, creating a digital identification that accesses and verifies a TouchCredit™ account at an online based website. TouchCredit™ will be a credit issuing company that can simply and securely authenticate and authorize transactions from users-to-server utilizing the latest in biometric technology. The system of the invention will authenticate a consumer's identity and consent to engage in a credit/debit transaction.

It will be apparent to those skilled in the art that various modifications and variations can be made in the system and processes of the present invention without departing from the spirit or scope of the invention. In addition to the illustrative biometric payment embodiment discussed herein, including any sponsoring organizations, issuing bank(s), company(s) that issue credit lines or credit services, or central biometric clearinghouse may be, for example, any organization or entity.

The present invention covers the modifications and variations of this invention provided they come within the scope of the appended claims and their equivalents. In this context, equivalents means each and every implementation for carrying out the functions recited in the claims, even those not explicitly described herein.

What is claimed is:

1. A method for securing computer network credit transactions using biometrics comprising the steps of:
a) a buyer registering personal information and at least one biometric sample with a detection server via a computer network;
b) the detection server communicating with computer systems of a credit-issuing institution to establish a credit account for the buyer;
c) the detection server establishing an account for the buyer if the credit issuing institution approves credit for the buyer;
d) the detection server forwarding the biometric sample to a third party clearinghouse, which enrolls the biometric sample to register the buyer;
e) the buyer accessing a seller's computer network site to make a purchase;
f) the buyer accessing the detection server and submits at least one biometric sample
g) the detection server forwarding the biometric sample to the third party clearinghouse;
h) the clearinghouse performing a match of the biometric sample and returning the result of the match to the detection server;
i) the detection server obtaining a single use credit card account number from the credit-issuing institution upon successful match from the third party clearinghouse; and
j) The detection server forwarding the single use credit card account number to the buyer.

2. The method of claim 1 further comprising the steps of:
a) providing a purchase form on the seller's computer network site which is automatically populated with the single use credit card number;
b) the seller's computer network site communicating with the seller's financial institution to clear transaction;
c) the seller's financial institution communicating with the credit-issuing institution to assess whether the buyer has sufficient credit to complete the purchase; and
d) the buyer's account being debited and the seller's account being credited once a determination of credit is established.

3. The method of claim 2 wherein the seller's financial institution transmits the single use credit card number to the credit-issuing institution in order to allow the credit issuing institution to locate the buyer's account.

4. The method of claim 1 wherein all transactions are conducted over the Internet and the detector server and the computer network site comprise web sites.

5. The method of claim 1 wherein the seller does not register any information directly with the detection server.

6. The method of claim 1 wherein the biometric sample is selected from the group consisting of a facial-scan, a finger-scan, a hand-scan, an iris-scan, a keystroke-scan, a signature-scan, a voice-scan, a DNA-scan and a retina-scan.

7. The method of claim 1 wherein the detection server is an Internet-based computer system that facilitates processing of online applicant's forms, communication with the third party clearinghouse, and communication with external financial service systems.

8. The method of claim 1 wherein the credit issuing institution's computer systems are external to the detection server.

9. The method of claim 1 wherein the credit-issuing institution verifies identity, employment and credit worthiness.

10. The method of claim 1 wherein data is encrypted during transmission over the computer network.

11. The method of claim 1 wherein the buyer has a unique account number for use by the detection server.

12. The method of claim 1 wherein the buyer selects an account number when registering with the detection server.

13. The method of claim 1 wherein the buyer has an account number auto-assigned by the detection server.

14. The method of claim 11 wherein the unique account number is stored on the buyer's computer.

15. The method of claim 14 wherein the manner in which the buyer account number is released to the detection server is selected from the group consisting of a manual PIN, an internet cookie, a system tray icon, a hotkey, and a desktop icon.

16. The method of claim 1 wherein biometric matching is performed only at the third party clearinghouse.

17. The method of claim 1 wherein the buyer inputs data via a device selected from the group consisting of a laptop computer, a desktop computer, a mobile telephone, and a personal digital assistant.

18. The method of claim 1 further comprising the following steps:
a) after initial registration with the detection server, a biometric device is provided to the buyer; and
b) the buyer enrolls a second time using the biometric device.

19. The method of claim 18 wherein the buyer is granted a higher credit limit upon enrollment with the biometric device.

20. The method of claim 1 wherein no biometric images are stored during the steps of claim 1, but instead biometric templates are stored.

21. A method for securing web-based credit transactions using biometrics comprising the steps of:
a) a buyer registering personal information and at least one biometric sample with a detection server via the Internet;
b) the detection server communicating with computer systems of a credit-issuing institution to establish a credit account for the buyer;
c) the detection server establishing an account for the buyer if the credit issuing institution approves credit for the buyer;
d) the detection server forwarding the biometric sample to a third party clearinghouse, which enrolls the biometric sample;
e) the buyer accessing a seller's Internet site to make a charge transaction;
f) the buyer accessing the detection server and submitting at least one biometric sample;
g) the detection server forwarding the biometric sample to the third party clearinghouse;
h) the clearinghouse performing a match of the biometric sample and returning the result of the match to the detection server; and
i) the detection server forwarding a single use credit card account number to the buyer upon successful match from the third party clearinghouse.

22. The method of claim 21 wherein the credit issuing institution provides the detection server with a list of single use credit card account numbers at regular intervals.

23. A method for securing web-based debit transactions using biometrics comprising the steps of:
a) a buyer registering personal information and at least one biometric sample with a detection server via the Internet;
b) the detection server communicating with computer systems of a financial institution to establish a credit account for the buyer;
c) the detection server establishes an account for the buyer;
d) the detection server forwarding the biometric sample to a third party clearinghouse, which enrolls the biometric sample;
e) The buyer accessing a seller's Internet site to make a purchase;
f) The buyer accessing the detection server and submitting at least one biometric sample;
g) The detection server forwarding the biometric sample to the third party clearinghouse;
h) The clearinghouse performing a match of the biometric sample and returning the result of the match to the detection server;
i) Upon the successfully match from the third party clearinghouse, the detection server obtaining a single use debit card account number from the financial institution; and
j) The detection server forwarding a single use credit card account number to the buyer.

24. A system for securing web-based credit transactions using biometrics comprising the steps of:
a) providing a means for buyer registration, wherein personal information and at least one biometric sample is registered with a detection server via the Internet;
b) providing a means for communicating, wherein the detection server communicates with computer systems of a credit-issuing institution to establish a credit account for the buyer;
c) providing a means for establishing an account for buyer upon the credit issuing institution-approving credit;
d) providing a means for allowing the detection server to forward the biometric sample to a third party clearinghouse, which enrolls the biometric sample;
e) providing a means for buyer to access a seller's Internet site to make a purchase;
f) providing a means for the buyer to access the detection server and submit at least one biometric sample;
g) providing a means for the detection server to forward the biometric sample to the third party clearinghouse;
h) providing a means for the clearinghouse to perform a match of the biometric sample and to return the result to the detection server;
i) providing a means for transmission, wherein upon successful match from the third party clearinghouse, the detection server obtains a single use credit card account number from the credit-issuing institution; and
j) providing a means for the detection server to forward the single use credit card account number to the buyer.
